(19) United States
(12) Patent Application Publication
(10) Pub. No.: US 2025/0040473 A1
(43) Pub. Date: Feb. 6, 2025

(54) PLATFORM STRUCTURE FOR ELECTRICALLY DRIVEN RICE TRANSPLANTER

(71) Applicant: THE INDUSTRY & ACADEMIC COOPERATION IN CHUNGNAM NATIONAL UNIVERSITY (IAC), Daejeon (KR)

(72) Inventors: Yong Joo KIM, Daejeon (KR); Hyeon Ho JEON, Daejeon (KR)

(21) Appl. No.: 18/716,161

(22) PCT Filed: Oct. 12, 2022
(86) PCT No.: PCT/KR2022/015334

§ 371 Date: Jun. 4, 2024

(30) Foreign Application Priority Data
Dec. 6, 2021 (KR) 10-2021-0172952

(51) Int. Cl. A01C 11/02; B60K 1/04

(52) U.S. Cl. CPC A01C 11/02; B60K 1/04

(57) ABSTRACT

The present invention relates to a platform for an electrically driven rice transplanter having an improved platform structure with a lowered center of gravity to prevent the risk of overturning when entering and exiting an open field due to thin wheels of the rice transplanter. The platform comprises: a battery; and a front wheel part and a rear wheel part driven by the battery. The front wheel part has: a front wheel motor receiving power from the battery; a front wheel transmission connected to the front wheel motor; and a front wheel vehicle shaft connected to the front wheel transmission to drive front wheels. The rear wheel part has: a rear wheel motor receiving power from the battery; a rear wheel transmission connected to the rear wheel motor; and a rear wheel vehicle shaft connected to the rear wheel transmission to drive rear wheels.

### TECHNICAL FIELD

The present disclosure relates to a platform for an electrically driven rice transplanter having an improved platform structure with a lowered center of gravity to prevent the risk of overturning when entering and exiting an open field due to thin wheels of the rice transplanter.

### BACKGROUND ART

As a prior art regarding an electric working machine and a platform for a transplanter, in Korean Patent No. 10-1622119 (registered May 12, 2016), there has been disclosed a technology about a hydraulic 2-dimensional moveable up-and-down type frame for an agricultural vehicle, the frame being available for each of a transplanter and a field cultivator, having a simple structure, being convenient to use, having a light driving system, having a simple configuration, having a low failure ratio, and having a low maintenance cost.

Further, in Korean Patent No. 10-1945539 (registered Jan. 29, 2019), there has been disclosed a transplanter characterized by including a vehicle body for driving, a planting unit having a float that can come in contact with the ground, and a controller controlling up-down movement of the planting unit, in which the controller controls the up-down movement on the basis of acceleration of the float and corrects the difference between the position of the float and a target value of the position of the float.

Further, in Korean Patent No. 10-1235209 (registered Feb. 14, 2013), there has been disclosed a technology about a riding type rice transplanter with fertilizing equipment that does not need soil covering for covering the ground with soil after applying a fertilizer by directly spraying a fertilizer onto seedbeds mounted on the riding type transplanter rather than a paddy field to which rice plants are transplanted, that reduces fertilizers to be scattered by applying fertilizers only to areas in which rice plants are transplanted rather than the entire paddy field, and can reduce contamination of paddy fields.

Further, Korean Patent No. 10-1724821 (registered Apr. 3, 2017) relates to a partial tiller and a rice transplanter comprising the partial tiller, more particularly to a technology about a partial tiller that can perform partial cultivation simultaneously with transplanting, fertilizing, and applying of herbicides, and a rice transplanter comprising the partial tiller.

### CITATION LIST

### Patent Literature

### [Patent Literature 1]

Korean Patent No. 10-1622119 (registered May 12, 2016)

### [Patent Literature 2]

Korean Patent No. 10-1945539 (registered Jan. 29, 2019)

### [Patent Literature 3]

Korean Patent No. 10-1235209 (registered Feb. 14, 2013)

### [Patent Literature 4]

Korean Patent No. 10-1724821 (registered Apr. 3, 2017)

### SUMMARY OF INVENTION

### Technical Problem

Since transplanters have thin wheels for the characteristics thereof and have a high risk of overturning when entering and exiting an open field, an objective of the present disclosure is to prevent these problems.

Further, an objective of the present disclosure is to lower the center of gravity of a transplanter by disposing a battery at the lower portion of the center of the vehicle.

Further, an objective of the present disclosure is to smoothly transmit power to a transplant part and a fertilizing unit by making the capacity of a rearwheel motor larger than the capacity of a frontwheel motor.

### Solution to Problem

In order to achieve the objectives, the present disclosure relates to [1] a platform for an electrically driven rice transplanter, the platform including: a battery (100); and a front wheel part (200) and a rear wheel part (300) driven by the battery (100), wherein the front wheel part (200) has a front wheel motor (210) receiving power from the battery (100), a front wheel transmission (220) connected to the front wheel motor (210), and a front wheel vehicle shaft (240) connected to the front wheel transmission (220) to drive front wheels (230), the rear wheel part (300) has a rear wheel motor (310) receiving power from the battery (310), a rear wheel transmission (320) connected to the rear wheel motor (310), and a rear wheel vehicle shaft (340) connected to the rear wheel transmission (320) to drive rear wheels (330), the battery (100) is provided between the front wheel motor (210) and the rear wheel motor (310), and a transplant part (400) is fixed to the rear of the rear wheel part (300).

Further, the present disclosure relates to the platform for an electrically driven rice transplanter of [1], in which [2] the rear wheel transmission (320) supplies power to a transplant part driving unit (510) of the transplant part (400).

Further, the present disclosure relates to the platform for an electrically driven rice transplanter of [1], in which [3] a battery management system (BMS) (110) controlling the battery (100) is installed on a side of the battery (100).

Further, the present disclosure relates to the platform for an electrically driven rice transplanter of [2], in which [4] the transplant part (400) feeds seedbeds, moves seedbeds left and right, and performs transplanting.

### Advantageous Effects of Invention

The present disclosure has the configuration described above and can lower the center of gravity of a vehicle, so it is possible to reduce the risk of overturning when entering and exiting an open field, and accordingly, it is possible to prevent accidents.

Further, the present disclosure can conveniently operate a transplant part (400) and a fertilizing unit (500) by providing a rear wheel motor (310) having larger capacity than a front wheel motor (210).

### BRIEF DESCRIPTION OF DRAWINGS

FIG. 1 is a conceptual view of the present disclosure.

FIG. 2 is a conceptual view of a front wheel part and a rear wheel part of the present disclosure.

FIG. 3 is a detailed conceptual view of a battery unit of the present disclosure.

FIG. 4 is a conceptual view showing a transplant part and a fertilizing unit.

### DESCRIPTION OF EMBODIMENTS

The present disclosure relates to a platform for an electrically driven rice transplanter. The platform includes a battery 100, and a front wheel part 200 and a rear wheel part 300 driven by the battery 100, in which the front wheel part 200 has a front wheel motor 210 receiving power from the battery 100, a front wheel transmission 220 connected to the front wheel motor 210, and a front wheel vehicle shaft 240 connected to the front wheel transmission 220 to drive front wheels 230; the rear wheel part 300 has a rear wheel motor 310 receiving power from the battery 100, a rear wheel transmission 320 connected to the rear wheel motor 310, and a rear wheel vehicle shaft 340 connected to the rear wheel transmission 320 to drive rear wheels 330; the battery 100 is provided between the front wheel motor 210 and the rear wheel motor 310; and a transplant part 400 is fixed to the rear of the rear wheel part 300. The components are described hereafter in detail with reference to the drawings.

The transplanter of the present disclosure, which is mounted and moved on a large vehicle rather than directly moving on an open field, does not need multi-stage transmission (considers only stages for work), so it is preferable to reduce the weight and stably manage the center of gravity.

As shown in FIG. 2, the battery 100 of the present disclosure is a component for transmitting power to the front wheel part 200 and the rear wheel part 300.

The battery 100 drives the front wheel motor 210 and the rear wheel motor 310 to transmit power to the front wheel part 200 and the rear wheel part 300.

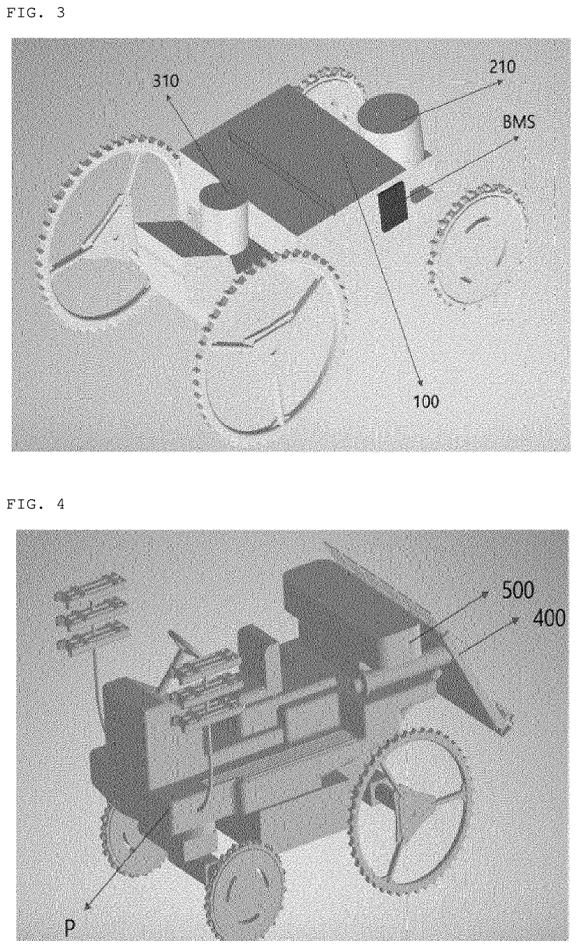

Further, as shown in FIG. 3, a battery management system (BMS) 110 that controls the battery 100 is installed on a side of the battery 100.

The battery 100 is installed between the front wheel motor 210 and the rear wheel motor 310. Through this installation, it is possible to maintain the center of gravity of the entire transplanter at a lower portion of the center. Since the present disclosure relates to stable management of the center of gravity of a transplanter, it is preferable to dispose the battery 100 at the position described above.

That is, the battery 100 accounts for a considerable portion of the weight of the transplanter, so when the battery 100 is disposed at the upper portion of a transplanter, the center of gravity goes up and accidents such as overturning of the transplanter, etc. occur more frequently.

The front wheel part 200 of the present disclosure includes: a front wheel motor 210 receiving power from the battery 100, a front wheel transmission 220 connected to the front wheel motor 210, and a front wheel vehicle shaft 240 connected to the front wheel transmission 220 to drive front wheels 230.

In the present disclosure, the front wheel part 200 requires relatively small driving force in comparison to the rear wheel part 300, so it may be given relatively small capacity in comparison to the rear wheel motor 310.

The rear wheel part 300 of the present disclosure includes: a rear wheel motor 310 receiving power from the battery 100, a rear wheel transmission 320 connected to the rear wheel motor 310, and a rear wheel vehicle shaft 340 connected to the rear wheel transmission 320 to drive rear wheels 330.

As shown in FIG. 4, in the present disclosure, the rear wheel motor 310 is supposed to drive not only the rear wheel vehicle shaft 340, but a transplant part 400 and a fertilizing unit 500, so it is preferable that the rear wheel motor 310 is given relatively large capacity in comparison to the front wheel motor 210.

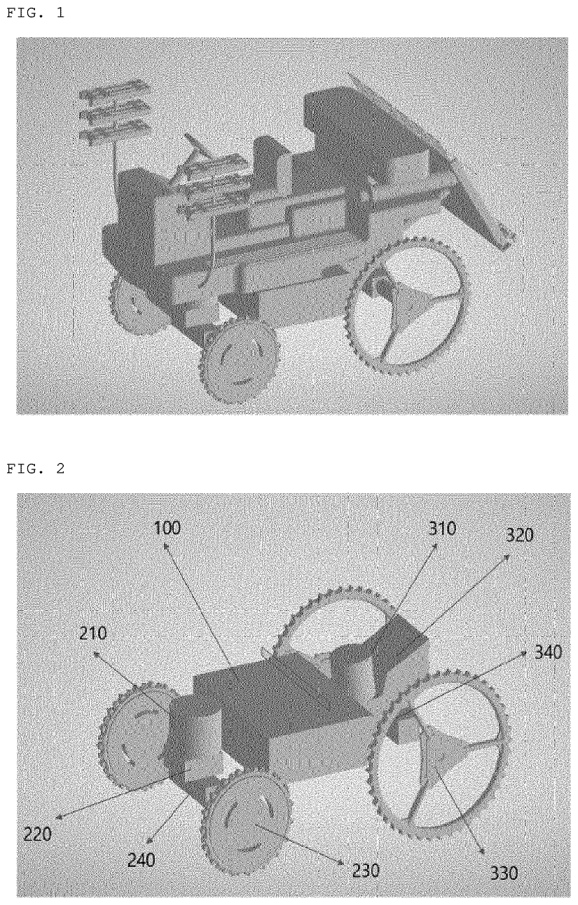

A steering system and driver seat of the present disclosure, as shown in FIG. 1, are disposed at the front portion and the center portion on a frame P provided at the upper side of the battery 100, the front wheel part 200, and the rear wheel part 300. Further, the transplant part 400 and the fertilizing unit 500 are disposed at the upper portion of the rear portion.

Although the present disclosure was described with reference to the exemplary drawings, it is apparent that the present disclosure is not limited to the embodiments and drawings in the specification and may be modified in various ways by those skilled in the art within the range of the spirit of the present disclosure. Further, even though the operation effects according to the configuration of the present disclosure were not clearly described with the above description of embodiments of the present disclosure, it is apparent that effects that can be expected from the configuration should be also admitted.

### REFERENCE SIGNS LIST

100: Battery
110: BMS
200: Front wheel part
210: Front wheel motor
220: Front wheel transmission
230: Front wheel
240: Front wheel vehicle shaft
300: Rear wheel part
310: Rear wheel motor
320: Rear wheel transmission
330: Rear wheel
340: Rear wheel vehicle shaft
400: Transplant part
500: Fertilizing unit
P: Frame

1. A platform for an electrically driven rice transplanter, the platform comprising:
a battery; and
a front wheel part and a rear wheel part driven by the battery,
wherein the front wheel part has a front wheel motor receiving power from the battery, a front wheel transmission connected to the front wheel motor, and a front wheel vehicle shaft connected to the front wheel transmission to drive front wheels,
the rear wheel part has a rear wheel motor receiving power from the battery, a rear wheel transmission connected to the rear wheel motor, and a rear wheel vehicle shaft connected to the rear wheel transmission to drive rear wheels,
the battery is provided between the front wheel motor and the rear wheel motor, and
a transplant part is fixed to the rear of the rear wheel part.

2. The platform of claim 1, wherein the rear wheel transmission supplies power to a transplant part driving unit of the transplant part.

3. The platform of claim 1, wherein a battery management system (BMS) controlling the battery is installed on a side of the battery.

4. The platform of claim 2, wherein the transplant part feeds seedbeds, moves seedbeds left and right, and performs transplanting.
